(19) United States
(12) Patent Application Publication
(10) Pub. No.: US 2003/0206134 A1
(43) Pub. Date: Nov. 6, 2003

(54) Partially deployed active phased array antenna array system

(76) Inventors: Erik Lier, Newtown, PA (US); John Charles Lopacki, Yardley, PA (US); Anthony W. Jacomb-Hood, Yardley, PA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/921,130

(22) Filed: Aug. 3, 2001

(51) Int. Cl. H01Q 3/22

(52) U.S. Cl. 342/368

(57) ABSTRACT

A partially deployed antenna array system that provides many beams per array and also reduces the amount of expensive advanced high density packaging that is required. The beamforming circuitry is located on the spacecraft bus, while the frequency converters, amplifiers, and antenna elements are deployed. The antenna array system for a spacecraft comprises a deployed antenna comprising a plurality of antenna elements operable to transmit or receive a radio frequency signal, a beamformer mounted in the body of the spacecraft operable to process a radio frequency signal or an intermediate frequency signal, and a transmission medium operable to communicate the radio frequency signal or the intermediate frequency signal between the beamformer and the deployed antenna. The transmission medium may comprise a fiber-optic link or alternatively may comprise a coaxial cable. The deployed antenna may comprise a plurality of antenna tiles.

### FIELD OF THE INVENTION

The present invention relates to a partially-deployed antenna array system, in which the beamforming circuitry is located on the spacecraft bus, while the frequency converters, amplifiers, and antenna elements are deployed.

### BACKGROUND OF THE INVENTION

A deployed transmit active phased array antenna for use on a spacecraft, which is based on the LOCKHEED MARTIN CORPORATION® SUPERTILE system, is described in U.S. Pat. No. 5,666,128. The described antenna array includes multiple input beam ports, signal power blocks, beamformers, including phase shifters and attenuators, up-converters (assuming intermediate frequency beamforming), solid state amplifiers, and antenna elements or sub-arrays. In the SUPERTILE system, the included circuitry is small and thin enough to allow the included circuitry to be mounted parallel to the aperture of the antenna array. The antenna array including the circuitry is deployed; that is, the antenna array is located some distance from the body of the spacecraft and is attached by support members to the spacecraft. As the antenna array is located a distance from the body of the spacecraft, the antenna array radiates the heat generated by the included circuitry directly into space without relying on the spacecraft bus for heat dissipation. Likewise, the antenna array does not take up real estate on the nadir deck of the spacecraft. In addition, the antenna array potentially allows for higher power payloads than was previously possible.

A problem arises with the SUPERTILE approach in that in order to fabricate components that are small and thin enough to be mounted parallel to the aperture of the antenna array, especially when the antenna array supports many beams, advanced high packaging density technologies must be used. In particular, the beamformers, which in many beam applications include a large amount of circuitry, must be fabricated using expensive advanced packaging technologies. In hopped multi-beam applications, it is preferred to generate high directivity beams, which requires a large array, at the expense of higher hop rate. Since the power generated by the active antenna array is thermally limited to the approximately 70 watts per square foot that can be dissipated, a larger array is required in order to accommodate a larger number of beams per array. With current technology, it is believed that a deployed active antenna array based on the SUPERTILE approach can be implemented with up to 24 beams per array.

An additional problem with the prior art is caused by the sensitivity of the antenna components to the thermal gradient across the antenna array, which can cause reduced antenna performance.

A need arises for a technique that will allow fabrication of an antenna array that provides many beams per array, reduces the need for expensive advanced high density packaging that is required, and places critical components of the antenna in a stable thermal environment.

### SUMMARY OF THE INVENTION

The present invention is a partially-deployed antenna system that provides many beams per array, reduces the need for expensive advanced high density packaging that is required, and places critical components of the antenna in a stable thermal environment. In the partially-deployed antenna array payload of the present invention, the beamforming circuitry is located on the spacecraft bus, which provides a stable thermal environment, while the frequency converters, amplifiers, and antenna elements are deployed. The partially-deployed antenna system may be advantageously used in spacecraft, aircraft, ships, vehicles, etc.

In one embodiment, an antenna system for a spacecraft comprises a deployed antenna comprising a plurality of antenna elements operable to transmit or receive a radio frequency signal, a beamformer mounted in a body of the spacecraft operable to process a radio frequency signal or an intermediate frequency signal, and a transmission medium operable to communicate the radio frequency signal or the intermediate frequency signal between the beamformer and the deployed antenna. The transmission medium may comprise a fiber-optic link. The fiber-optic link may comprise: a first converter operable to receive the radio frequency signal or the intermediate frequency signal, convert the radio frequency signal or the intermediate frequency signal to a light signal and to output the light signal, a fiber-optic cable operable to transmit the light signal between the beamformer and the antenna, and a second converter operable to receive the light signal, convert the light signal to recover the radio frequency signal or the intermediate frequency signal, and to output the radio frequency signal or the intermediate frequency signal. The deployed antenna may comprise a plurality of antenna tiles.

In one aspect of the present invention, the deployed antenna is transmitting at least one radio frequency signal and the beamformer is a radio frequency beamformer and the transmission medium comprises a fiber group, which contains a plurality of fiber-optic links. The signals that are to be transmitted are applied to the input ports of the beamformer, which, in a manner known to those skilled in the art, creates at its output ports the appropriate composite signals to drive each of the antenna elements. Each fiber optic link comprises: a first converter coupled to the beamformer and operable to convert an input radio frequency signal to a light signal and to output the light signal, a fiber-optic cable operable to transmit the light signal, and a second converter coupled to the antenna operable to receive the light signal and to convert the light signal to an output radio frequency signal, and the antenna further comprises: a power amplifier operable to receive the radio frequency signal from the second converter and to amplify the radio frequency signal, a filter operable to filter the amplified radio frequency signal and output the filtered radio frequency signal, and an antenna element operable to receive the filtered radio frequency signal and to radiate the filtered radio frequency signal. The deployed antenna may comprise a plurality of antenna tiles, each of which includes a plurality of elements.

In one aspect of the present invention, the beamformer comprises a plurality of power dividers, a plurality of phase and amplitude control circuits, and a plurality of power combiner circuits. Each power divider has a plurality of outputs, and is operable to receive a radio frequency signal, divide the received signal into a plurality of signals and output the plurality of divided signals. Each phase and amplitude control circuit is operable to receive a radio frequency signal from a power divider, set the phase and amplitude of the signal to a desired value and output the phase shifted and attenuated signal. Each power combiner circuit has a plurality of inputs and an output, each output is connected to a fiber optic link, each power combiner circuit is operable to receive radio frequency signals from a plurality of phase and amplitude control circuits, combine these signals into a composite signal, and output the composite signal. The plurality of power dividers, phase and amplitude control circuits and power combiners are arranged so that one of the plurality of outputs from each power divider is connected through a phase and amplitude control circuit to one of the plurality of inputs of each of the plurality of power combiners. One of the plurality of inputs to each power combiner is connected through a phase and amplitude control circuit to one of the plurality of outputs of each of the plurality of power dividers.

In one aspect of the present invention, the deployed antenna is transmitting a radio frequency signal and the beamformer is an intermediate frequency beamformer and the transmission medium comprises a fiber-optic link comprising: a first converter coupled to the beamformer and operable to convert an input intermediate frequency signal to a light signal and to output the light signal, a fiber-optic cable operable to transmit the light signal, and a second converter coupled to the antenna operable to receive the light signal and to convert the light signal to an output intermediate frequency signal, and the antenna further comprises: an up-converter operable to receive the intermediate frequency signal from the second converter, convert the intermediate frequency signal to a radio frequency signal, and output the radio frequency signal to the power amplifier, a power amplifier operable to amplify the radio frequency signal, and a filter operable to filter the amplified radio frequency signal and output the filtered radio frequency signal, and an antenna element operable to receive the filtered radio frequency signal and to radiate the filtered radio frequency signal. The deployed antenna may comprise a plurality of antenna tiles.

In one aspect of the present invention, the deployed antenna is receiving a radio frequency signal and the beamformer is a radio frequency beamformer and the antenna further comprises: an antenna element operable to receive the radio frequency signal and output the radio frequency signal, a filter operable to receive the radio frequency signal from the antenna element, filter the amplified frequency signal, and output the filtered radio frequency signal, and an amplifier operable to receive the radio frequency signal from the antenna element, amplify the radio frequency signal, and output an amplified radio frequency signal, and the transmission medium comprises a fiber-optic link comprising: a first converter coupled to the amplifier and operable to convert an input radio frequency signal to a light signal and to output the light signal, a fiber-optic cable operable to transmit the light signal, and a second converter coupled to the beamformer operable to receive the light signal and to convert the light signal to an output radio frequency signal. The deployed antenna may comprise a plurality of antenna tiles.

In one aspect of the present invention, the deployed antenna is receiving a radio frequency signal and the beamformer is an intermediate frequency beamformer and the antenna further comprises: an antenna element operable to receive the radio frequency signal and output the radio frequency signal, a filter operable to receive the radio frequency signal from the antenna element, filter the amplified frequency signal, and output the filtered radio frequency signal, an amplifier operable to receive the radio frequency signal from the antenna element, amplify the radio frequency signal, and output an amplified radio frequency signal, a down-converter operable to receive the amplified radio frequency signal from the amplifier, convert the radio frequency signal to an intermediate frequency signal, and output the intermediate frequency signal, and the transmission medium comprises a fiber-optic link comprising: a first converter coupled to the down-converter and operable to convert an input intermediate frequency signal to a light signal and to output the light signal, a fiber-optic cable operable to transmit the light signal, and a second converter coupled to the beamformer operable to receive the light signal and to convert the light signal to an output intermediate frequency signal. The deployed antenna may comprise a plurality of antenna tiles.

In one aspect of the present invention, the transmission medium comprises a coaxial cable.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of a spacecraft including the partially-deployed antenna array system of the present invention.

FIG. 2 is an exemplary block diagram of a transmitting embodiment of a portion of a partially deployed antenna array system shown in FIG. 1.

FIG. 3 is an exemplary block diagram of a partially deployed antenna array system shown in FIG. 2.

FIG. 4 is an exemplary view of a beamformer box shown in FIG. 3.

FIG. 5 is an exemplary schematic diagram of fiber-optic transmission links and antenna tiles for a transmitting embodiment of the antenna array system shown in FIG. 2.

FIG. 6 is an exemplary block diagram of a beamformer, according to the present invention.

FIG. 7 is a more detailed exemplary block diagram of the beamformer shown in FIG. 6.

FIG. 8 is an exemplary block diagram of a beamformer board shown in FIG. 3.

FIG. 9 is an exemplary block diagram of a receiving embodiment of a portion of a partially deployed antenna array system shown in FIG. 1.

### DETAILED DESCRIPTION OF THE INVENTION

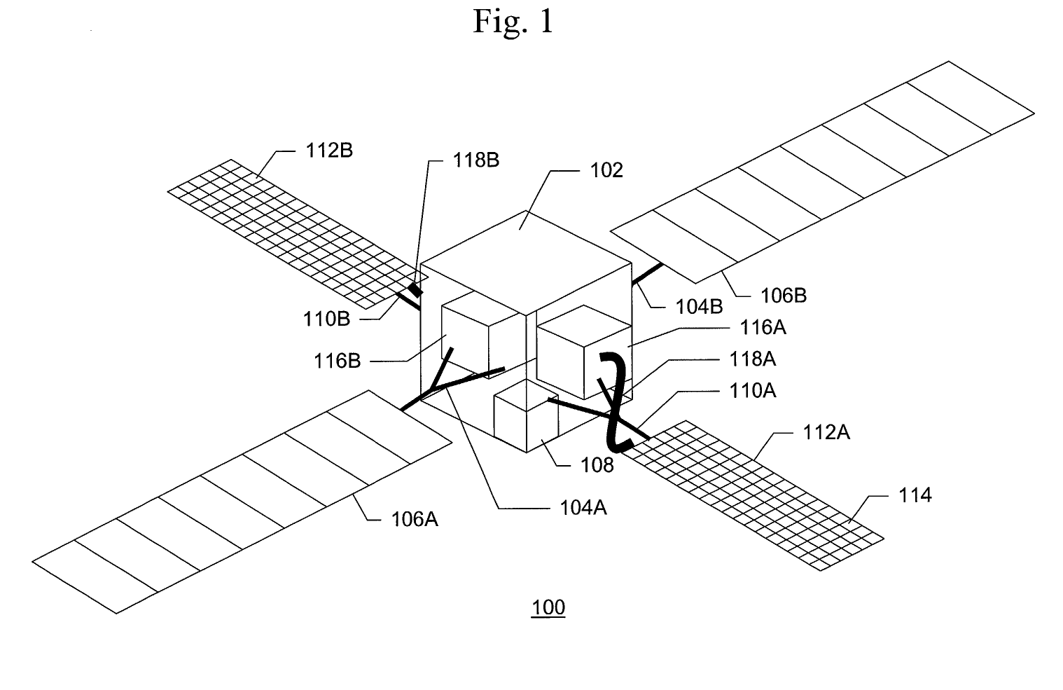

The present invention is a partially deployed antenna array system that provides many beams per array, reduces the need for expensive advanced high density packaging that is required, and places critical components of the antenna in a stable thermal environment. The partially-deployed antenna array system is suitable for use as a payload on a spacecraft platform. In the partially-deployed antenna array system of the present invention, the beamforming circuitry is located on the spacecraft bus, which provides a stable thermal environment and reduces thermal risk for the beamformer design, while the frequency converters, amplifiers, and antenna elements are deployed. An exemplary spacecraft 100 including the partially-deployed antenna array system of the present invention is shown in FIG. 1. Spacecraft 100 includes spacecraft body 102. Attached to spacecraft body 102 by support members 104A and 104B are deployed solar panels 106A and 106B, which produce electrical energy in known fashion. The produced electrical energy is stored in an electrical battery 108 for satisfying peak loads and for those intervals in which the solar panels may be in shadow. Attached to spacecraft body 102 by support members 110A and 110B are deployed antenna panels 112A and 112B, each of which comprises a plurality of deployed antenna tiles, such as tile 114. Included in spacecraft body 102 are beamformer boxes 116A and 116B, which are connected to antenna panels 112A and 112B by fiber groups 118A and 118B, respectively. Beamformer boxes 116A and 116B are not deployed, but rather are mounted on the spacecraft bus and provide the beamforming functionality for the antenna array system. Deployed antenna panels 112A and 112B include the conversion, amplification, filtering, and radiating functionality of the antenna array system. Thus, part of the antenna array system is deployed and part of the antenna array system is not deployed.

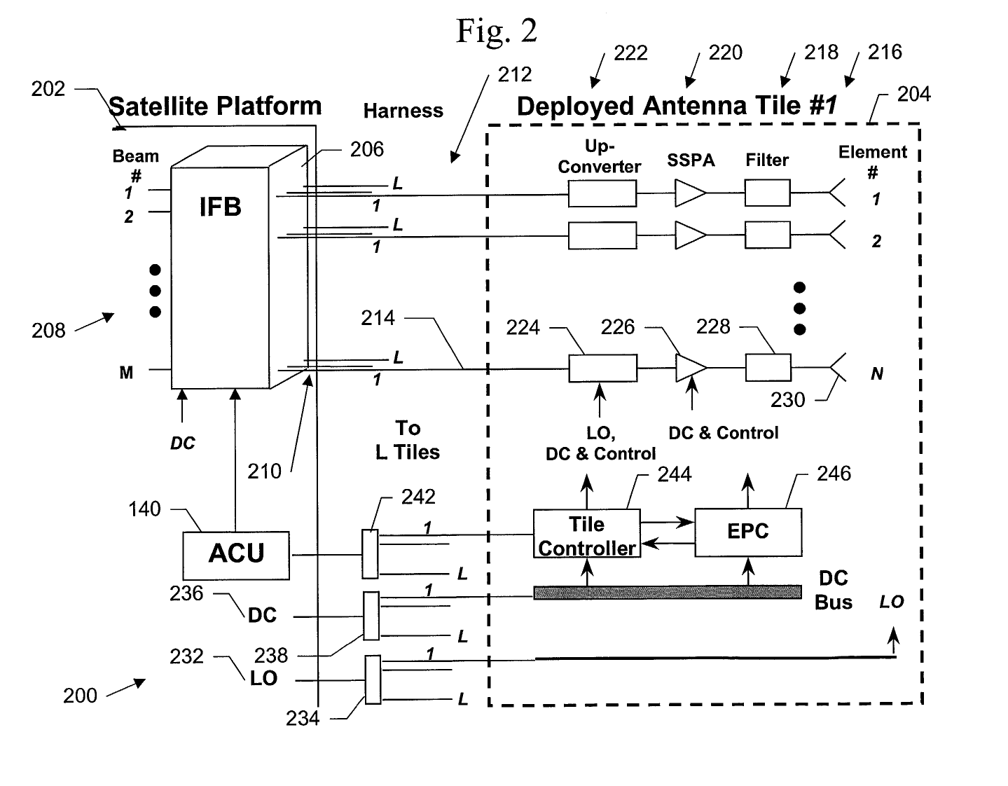

An exemplary block diagram of a portion of a partially deployed antenna array system 200, according to the present invention, is shown in FIG. 2. The example shown in FIG. 2 is a transmitting antenna array system example. However, the present invention contemplates and is equally applicable to receiving antenna array systems as well.

System 200 includes circuitry on satellite platform 202 and a plurality of deployed antenna tiles, such as antenna tile 204. In the embodiment shown in FIG. 2, satellite platform 202 includes intermediate frequency beamformer (IFB) 206. IFB 206 includes a number (M) of beamports 208, which are inputs to IFB 206, and a number (N×L) of element ports 210, which are outputs from IFB 206. The quantity M represents the number of beams that the antenna array has, while the quantity L represents the number of antenna tiles that the antenna array has. The quantity N represents the number of antenna elements in each tile.

As is well known, a beamformer, which may be an intermediate frequency beamformer, such as IFB 208, or a radio frequency beamformer, includes phase and amplitude control circuits that can be set to steer and shape one or more beams. The phase and amplitude control circuits are connected through power dividers and combiners. A signal entering a beamport is split into N×L elemental paths with a phase shifter and an attenuator in each path. Each elemental path is then combined with the corresponding elemental path from each of the M beam paths and ends in the element port. There is one element port for each of the antenna elements that make up each antenna tile. As there are N antenna elements per tile and L antenna tiles, there are N×L outputs from element ports 210.

The element ports 210 outputs are connected to the deployed antenna tiles such as tile 204. The N element ports associated with each tile are connected via a fiber group 212, which includes a transmission medium that communicates signals between IFB 206 and antenna tile 204. The preferred transmission medium between the bus-mounted beamformer and the antenna part of the active phased array is fiber-optic links. A fiber-optic link, such as link 214, includes a microwave-to-light converter (transmitter), a fiber-optic cable, and a light-to-microwave converter (receiver). The signals on fiber group 212 are connected to circuitry in antenna tile 204. Antenna tile 204 includes a plurality of antenna elements 216, a plurality of filters 218, a plurality of solid state power amplifiers 220, and a plurality of up-converters 222. For example, fiber-optic link 214 is connected to up-converter 224, which is connected to solid-state power amplifier 226, which is connected to filter 228, which is connected to antenna element 230.

While the preferred transmission medium between the bus-mounted beamformer and the antenna part of the active phased array is fiber-optic links, coaxial cables may also be used. However, coaxial cables are more sensitive to thermal variations which affects electric phase and thereby the antenna beam shape. In addition, coaxial cables require more deployment force when a large number of cables go across the deployment hinge, and are heavier and bulkier than fiber-optic links.

Filters 218 filter the amplified radio frequency signal in order to suppress spurious signals outside of the transmit frequency band to meet regulations and other system requirements. A typical filter is a corrugated waveguide filter for transmit as well as for receive. A waveguide filter offers low loss, which is critical since the filter, is located between the amplifier and the antenna element. For receiving antenna array system applications, filters 218 have the main purpose of suppressing the energy from the transmit antenna into the receive antenna.

Each antenna element, such as element 230 may be a single antenna or a small array of elements to meet certain efficiency and/or packaging requirements. A typical antenna element for a 12 GHz transmitting antenna array system is a 16-way power divider with 16 radiating dipole elements, such as that described in U.S. Pat. No. 5,870,063. The power divider offers low loss, while the dipole elements offer low thermal blockage to the waveguide surface, which is covered with optical solar reflector for improved thermal performance.

The example shown in FIG. 2 incorporates intermediate frequency (IF) beamforming. However, beamforming can be done at intermediate frequencies or at radio frequencies (RF). In an IF beamforming embodiment, up-converters (for transmitting antenna array systems) or down-converters (for receiving antenna array systems) are needed and will normally be located near the elemental amplifiers. Such an up/down converter is an active module that includes a mixer and requires a separate local oscillator (LO) signal.

System 200 includes a local oscillator 232, which generates the required LO signal. The LO signal is distributed by signal distributor 234 to each of the deployed antenna tiles, such as tile 204. Within each tile, the LO signal is distributed to the up-converters or down-converters in the tile. System 200 includes a direct current (DC) power supply 236, which generates DC power for the circuitry in the antenna tiles. The DC power is distributed by power distributor 238 to each of the deployed antenna tiles, such as tile 204. Within each tile, the DC power is distributed to the circuitry in the tile using the Electronic Power Conditioner (EPC) 246. System 200 includes an antenna control unit (ACU) 240, which generates control signals for the antenna tiles and the IFB 206. The ACU signal is distributed by signal distributor 242 to each of the deployed antenna tiles, such as tile 204. Within each tile, the ACU signal is distributed to a tile controller, such as tile controller 244. Tile controller 244 performs the necessary control functions for antenna tile 204, based on the input ACU signals. Tile controller 244 also communicates with electronic power conditioner (EPC) 246.

The LO signals, the DC power, and the ACU signals are carried by transmission media from satellite platform 202 to the antenna tiles, such as antenna tile 204. The DC power is carried over wiring, such as copper wire, while the LO signals and the ACU signals may be carried over coaxial cable or fiber-optic links. If fiber-optic links are used, such a link includes a microwave-to-light converter (transmitter), a fiber-optic cable, and a light-to-microwave converter (receiver). While the preferred transmission medium is fiber-optic links, coaxial cables may also be used. However, coaxial cables are more sensitive to thermal variations which affects electric phase and thereby the antenna beam shape. In addition, coaxial cables require more deployment force when a large number of cables go across the deployment hinge, and are heavier and bulkier than fiber-optic links.

In an RF beamforming embodiment, IFB 206 is replaced by an RF beamformer, which performs beamforming at the operating frequency of the antenna array system. In an RF beamforming embodiment, the up-converters or down-converters, local oscillator and local oscillator distribution circuitry are not needed.

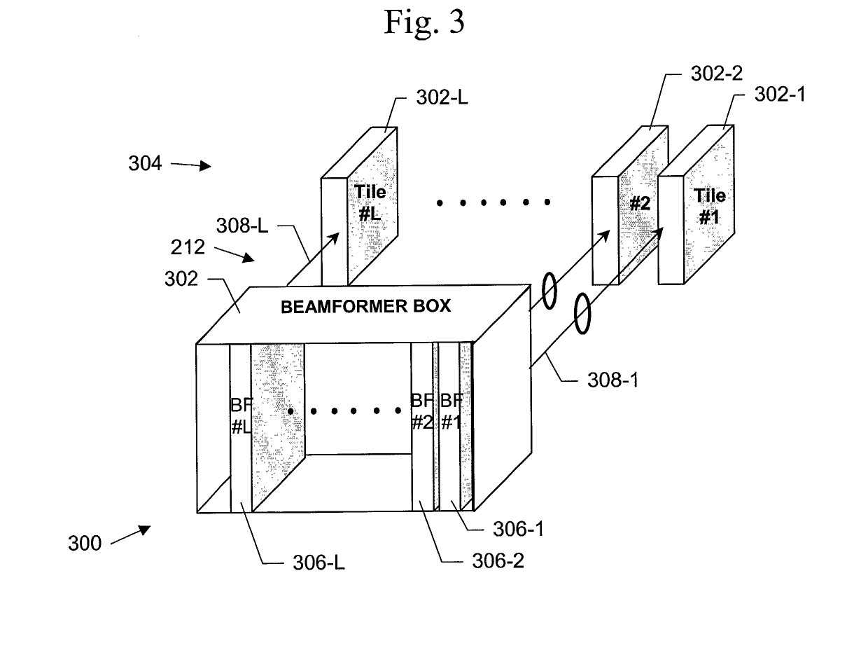

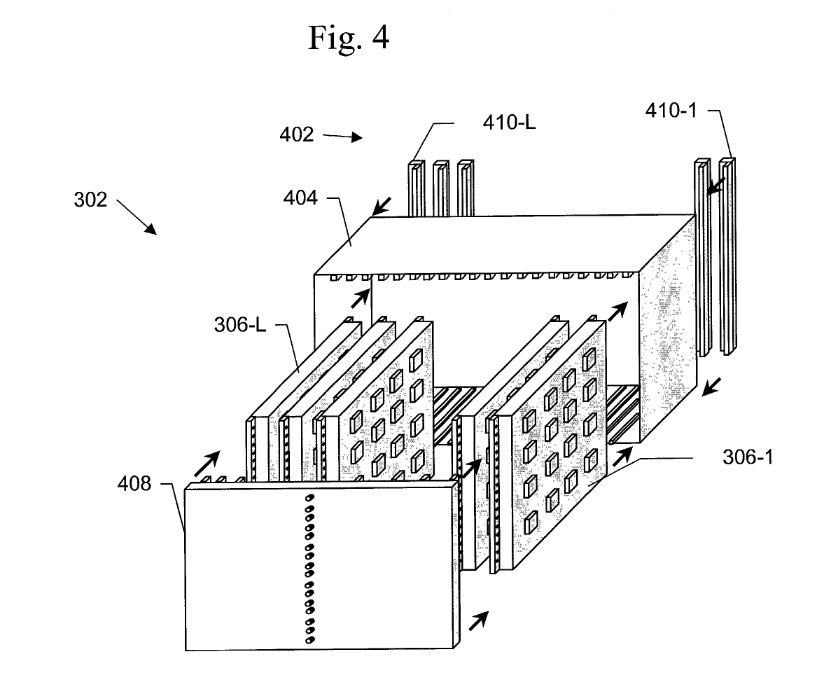

A simplified exemplary diagram of a beamformer box 302, of which beamformer boxes 116A and 116B, shown in FIG. 1, are examples, and a plurality of deployed antenna tiles 304, is shown in FIG. 3. For clarity, certain details are reserved for FIG. 4. Beamformer box 302 is mounted on the system bus of satellite platform 202, while antenna tiles 304 are deployed some distance from the body of the spacecraft and are attached by support members to the spacecraft. Beamformer box 302 contains a beamformer, such as IFB 206, shown in FIG. 2. The beamformer may be made up of a plurality of beamformer boards 306-1 to 306-L mounted in beamformer box 302. Antenna tiles 304 are connected to beamformer boards 306-1 to 306-L by fiber group 212, which includes a plurality of links, such as link 308-1. Each fiber group contains N IF optical fibers and connects one beamformer board to one antenna tile. For example, link 308-1 connects beamformer board 306-1 to antenna tile 302-1. Likewise, link 308-L connects beamformer board 306-L to antenna tile 302-L.

The design shown in FIG. 3 provides considerable flexibility in the design of the antenna array system. For example, the number of antenna tiles in the antenna array system or the number of beams used may be changed without significant redesign of the system.

A more detailed view of beamformer box 302 is shown in FIG. 4. Included are back panel boards 402, beamformer frame 404, beamformer boards 306, and front panel board 408. Back panel boards 402, which include a plurality of back panel boards, such as boards 410-1 to 410-L, contain the circuitry necessary to transmit signals over the fiber-optic links. Beamformer frame 404 includes mechanical structure needed to hold the back panel boards 402, beamformer boards 306-1 to 306-L, and front panel board 408. Beamformer frame 404 supports plug in connection of signals to and among beamformer boards 306, front panel board 408 and back panel boards 402, including RF signals, IF signals, control signals, and DC power. Beamformer boards 306 include a plurality of beamformer boards, such as beamformer boards 306-1 to 306-L. Front panel board 408 provides L-way division of each beam input.

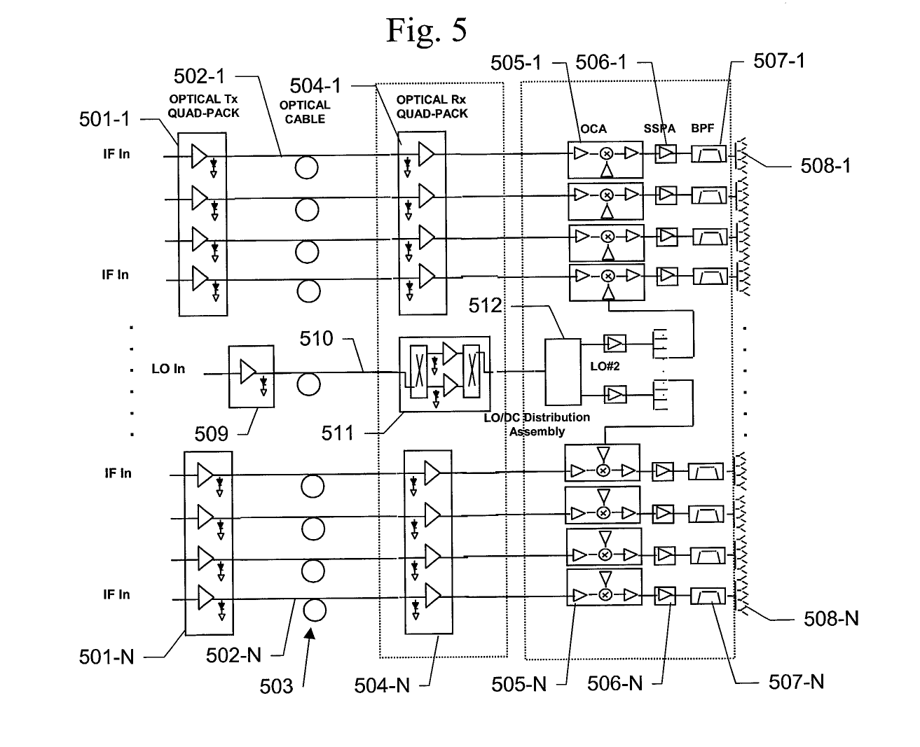

An exemplary schematic diagram of the fiber-optic transmission links and the antenna tiles for a transmitting embodiment of the antenna array system, which is shown in FIG. 2, is shown in FIG. 5. The intermediate frequency (IF) signals from the beamformer are input to optical transmitters 501-1 to 501-N. Optical transmitters 501-1 to 501-N modulate the input electrical IF signals onto optical carrier signals and transmit the modulated optical signals onto optical cables 502-1 to 502-N. Optical cables 502-1 to 502-N are arranged so as to form fiber group 503. Optical cables 5021 to 502-N are connected to the inputs of optical receivers 504-1 to 504-N. Optical receivers 504-1 to 504-N extract the IF signals from the modulated optical signals and output recovered electrical IF signals to frequency converters 505-1 to 505-N. Frequency converters 505-1 to 505-N mix the received IF signals with local oscillator (LO) signals and output radio frequency (RF) signals that are at the operational frequency of the antenna array system. The RF signals are amplified by solid state power amplifiers 506-1 to 506-N, filtered by bandpass filters 507-1 to 507-N and input to antenna elements 508-1 to 508-N.

The LO signals that are input to frequency converters 505-1 to 505-N are generated by circuitry located in the body of the spacecraft and are transmitted to the antenna panels over fiber group 503. The LO signal is input to optical transmitter 509, transmitted over optical cable 510, received by optical receiver 511, and distributed to frequency converters 505-1 to 505-N by distribution circuitry 512.

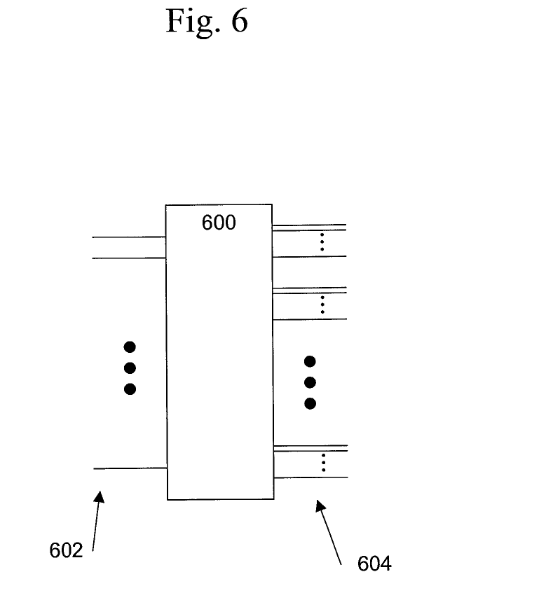

An exemplary block diagram of a beamformer 600 is shown in FIG. 6. Beamformer 600 has a number (M) of beamports 602, which are inputs to the beamformer, and a number (N×L) of element ports 604, which are outputs from the beamformer. Each element port is connected to one antenna element. The quantity M represents the number of beams that the antenna array has, while the quantity L represents the number of antenna tiles that the antenna array has. As is well known, a signal entering a beamport is split into N×L elemental paths with a phase shifter and an attenuator in each path. Each elemental path is then combined with the corresponding elemental path from each of the M beam paths and ends in the element port. There is one element port for each of the antenna elements that make up the antenna array. As there are N antenna elements per antenna tile and L antenna tiles, there are N×L element ports 604.

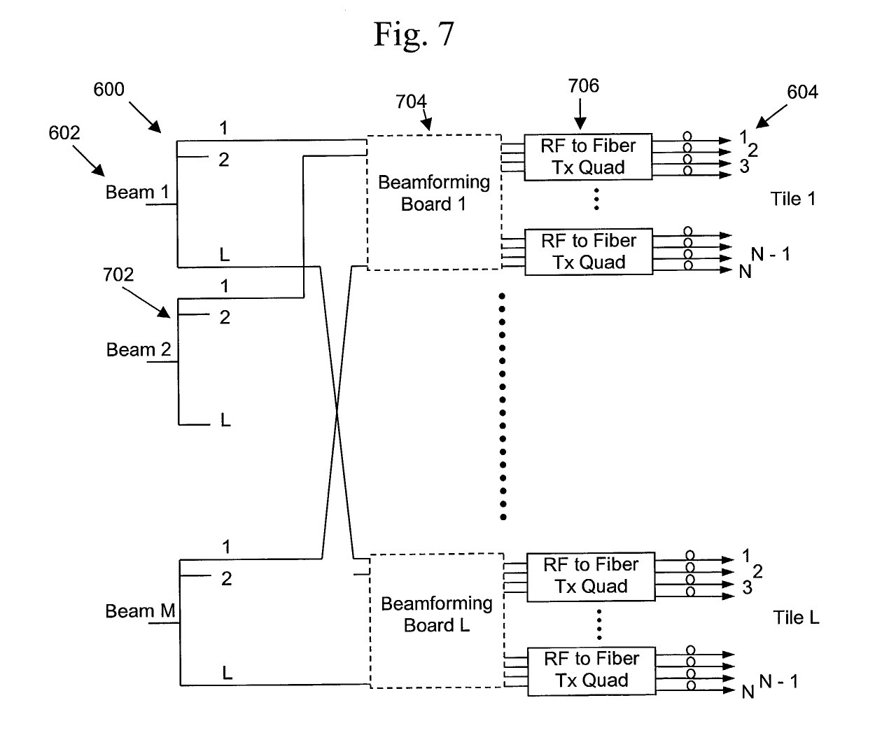

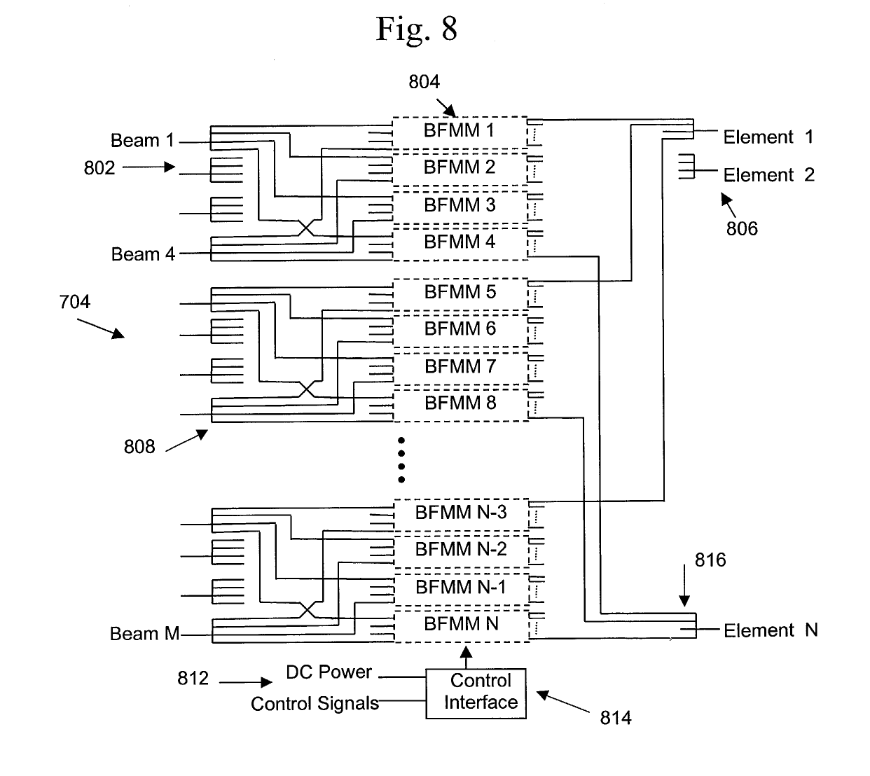

A more detailed exemplary block diagram of beamformer 600, shown in FIG. 6, is shown in FIG. 7. Beamformer 600 has a number (M) of beamports 602, which are inputs to the beamformer, and a number (N×L) of element ports 604, which are outputs from the beamformer. Beamformer 600 includes a plurality of power splitters, such as power splitter 702, each of which splits an incoming beam signal into a plurality of signals, which are connected to the plurality of beamforming boards , such as beamforming board 704. The details of beamforming board 704 are shown in FIG. 8. In the present invention, the output signals from the beamformer are the input signals to the antenna tiles. These signals are transmitted to the deployed antenna array, for example by optical transmitters 706 over fiber optic transmission links.

An exemplary block diagram of a beamformer board 704, which is included in a beamformer box, is shown in FIG. 8. Beamformer board 704 includes a plurality of beam inputs 802 and a plurality of element port outputs 806. Beam inputs 802 to beamformer board 704 are connected to the outputs of the power splitters 702. Each element port output 806 is connected to one antenna element. The N element port outputs provided by each beamforming board 704 feed the N antenna elements in a single tile 304.

Beamformer board 704 includes a plurality of power splitters, such as power splitter 808, a plurality of beamformer matrix modules (BFMMs), such as BFMM 804, and a plurality of power combiners, such as power combiner 816. Each BFMM includes a plurality of power splitters, a plurality of phase shifters, a plurality of attenuators and a plurality of power combiners. Each power splitter divides one of the signals, which resulted when an incoming beam signal was split by power splitter 808, into a plurality of signals. Each of these signals is processed by a phase shifter, to form the needed phase of the signal. Each phase shifted signal is attenuated by an attenuator, to form the needed amplitude of the phase shifted signal. Phase shifted and attenuated signals from each beam are combined by power combiners in the BFMM and external to the BFMM 816 to form composite multi-beam signals that are transmitted to the antenna elements. Beamformer board 704 also includes power supply and control/telemetry connections 812 and power supply and control/telemetry circuitry 814.

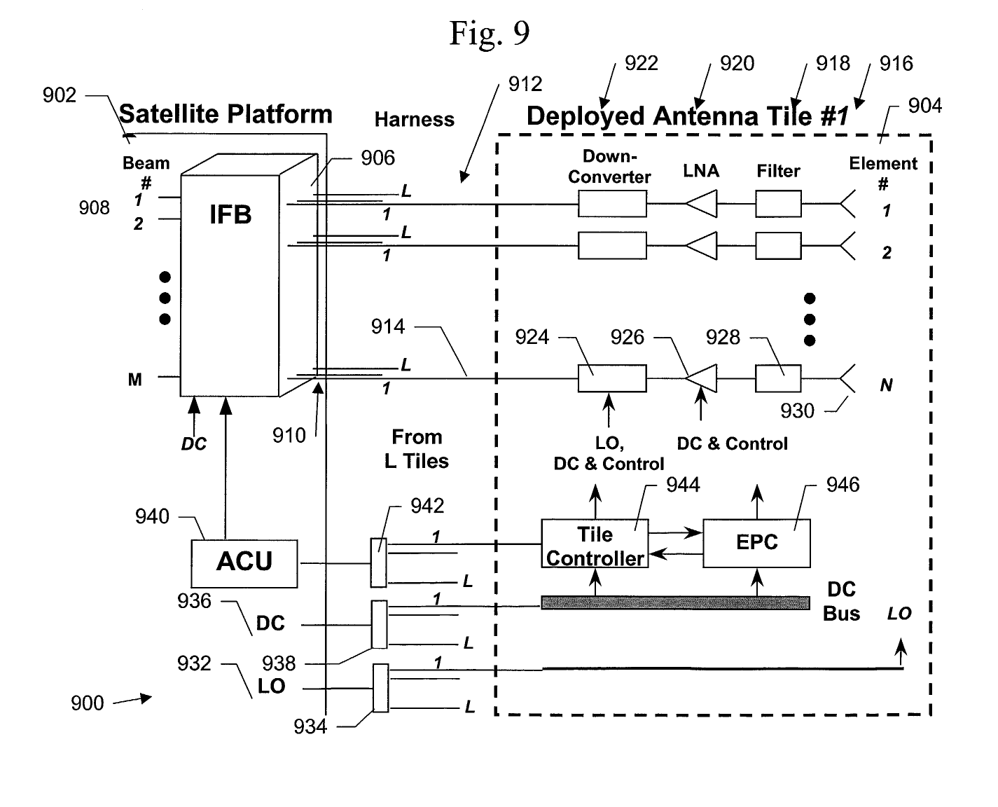

An exemplary block diagram of a portion of a partially deployed antenna array system 900, according to the present invention, is shown in FIG. 9. The example shown in FIG. 9 is a receiving antenna array system example.

System 900 includes circuitry on satellite platform 902 and a plurality of deployed antenna tiles, such as antenna tile 904. In the embodiment shown in FIG. 9, satellite platform 902 includes intermediate frequency beamformer (IFB) 906. IFB 906 includes a number (M) of beamports 908, which are outputs from IFB 906, and a number (N×L) of element ports 910, which are inputs to IFB 906. The quantity M represents the number of beams that the antenna array has, while the quantity L represents the number of antenna tiles that the antenna array has. There is one element port for each of the antenna elements that make up each antenna tile. As is well known, a beamformer includes mainly passive components—power splitters, power combiners, phase shifters, and attenuators. Receiving beamformers are similar to transmitting beamformers and include similar components.

The element ports 910 inputs are connected to the outputs of the deployed antenna tiles such as tile 904. Each of the N×L element ports has one input connected to one of the N×L outputs of the L antenna tiles. The element ports are connected via L fiber groups such as fiber group 912, which includes a transmission medium that communicates signals to IFB 906 from antenna tiles such as antenna tile 904. The preferred transmission medium between the bus-mounted beamformer and the antenna part of the active phased array is fiber-optic links. A fiber-optic link, such as link 914, includes a microwave-to-light converter (transmitter), a fiber-optic cable, and a light-to-microwave converter (receiver). The signals on fiber group 912 are connected to circuitry in antenna tile 904. Antenna tile 904 includes a plurality of antenna elements 916, a plurality of filters 918, a plurality of low-noise amplifiers 920, and a plurality of down-converters 922. For example, antenna element 930 is connected to filter 928, which is connected to low-noise amplifier 926, which is connected to down-converter 924, which is connected to fiber-optic link 914.

Filters 918 filter the received radio frequency signal in order to reduce the energy from the transmit antenna into the receive antenna. A typical filter is a corrugated waveguide filter for receive as well as for transmit. A waveguide filter offers low loss, which is critical since the filter, is located between the amplifier and the antenna element.

Each antenna element, such as element 930 may be a single antenna or an small array of elements to meet certain efficiency and/or packaging requirements. A typical antenna element for a 30 GHz receiving antenna array system is a single horn element, which also offers low loss. The example shown in FIG. 9 incorporates intermediate frequency (IF) beamforming. However, beamforming can be done at an intermediate frequency or at the radio frequencies (RF). In an IF beamforming embodiment, up-converters (for transmitting antenna array systems) or down-converters (for receiving antenna array systems) are needed and will normally be located near the elemental amplifiers. Each up/down converter is an active module that includes a mixer and requires a separate local oscillator (LO) signal.

System 900 includes a local oscillator 932, which generates the required LO signal. The LO signal is distributed by signal distributor 934 to each of the deployed antenna tiles, such as tile 904. Within each tile, the LO signal is distributed to the up-converters or down-converters in the tile. System 900 includes a direct current (DC) power supply 936, which generates DC power for the circuitry in the antenna tiles. The DC power is distributed by power distributor 938 to each of the deployed antenna tiles, such as tile 904. Within each tile, the DC power is conditioned by the EPC 946 and distributed to the circuitry in the tile. System 900 includes an antenna control unit (ACU) 940, which generates control signals for the antenna tiles. The ACU signal is distributed by signal distributor 942 to each of the deployed antenna tiles, such as tile 904. Within each tile, the ACU signal is distributed to a tile controller, such as tile controller 944. Tile controller 944 performs the necessary control functions for antenna tile 904, based on the input ACU signals. Tile controller 944 also communicates with electronic power conditioner (EPC) 946.

The LO signals, the DC power, and the ACU signals are carried by transmission media from satellite platform 902 to the antenna tiles, such as antenna tile 904. The DC power must be carried over wiring, such as copper wire, while the LO signals and the ACU signals may be carried over coaxial cable or fiber-optic links. If fiber-optic links are used, such a link includes a microwave-to-light converter (transmitter), a fiber-optic cable, and a light-to-microwave converter (receiver). While the preferred transmission medium is fiber-optic links, coaxial cables may also be used. However, coaxial cables are more sensitive to thermal variations which affects electric phase and thereby the antenna beam shape. In addition, coaxial cables require more deployment force when a large number of cables go across the deployment hinge, and are heavier and bulkier than fiber-optic links.

In an RF beamforming embodiment, IFB 906 is replaced by an RF beamformer, which performs beamforming at the operating frequency of the antenna array system. In an RF beamforming embodiment, the up-converters or down-converters, local oscillator, and local oscillator distribution circuitry are not needed.

Although specific embodiments of the present invention have been described, it will be understood by those of skill in the art that there are other embodiments that are equivalent to the described embodiments. For example additional components may be included to provide redundancy and thus increase system reliability. Accordingly, it is to be understood that the invention is not to be limited by the specific illustrated embodiments, but only by the scope of the appended claims.

What is claimed is:

1. An antenna system comprising:
a deployed antenna comprising a plurality of antenna elements operable to transmit or receive a radio frequency signal;
a beamformer mounted in a body of the spacecraft operable to process a radio frequency signal or an intermediate frequency signal; and
a transmission medium operable to communicate the radio frequency signal or the intermediate frequency signal between the beamformer and the deployed antenna.

2. The antenna system of claim 1, wherein the transmission medium comprises a fiber-optic link.

3. The antenna system of claim 2, wherein the fiber-optic link comprises:
a first converter operable to receive the radio frequency signal or the intermediate frequency signal, convert the radio frequency signal or the intermediate frequency signal to a light signal and to output the light signal;
a fiber-optic cable operable to transmit the light signal between the beamformer and the antenna; and
a second converter operable to receive the light signal, convert the light signal to recover the radio frequency signal or the intermediate frequency signal, and to output the radio frequency signal or the intermediate frequency signal.

4. The antenna system of claim 3, wherein the deployed antenna comprises at least one antenna tile.

5. The antenna system of claim 1, wherein the deployed antenna comprises at least one antenna tile.

6. The antenna system of claim 5, wherein the transmission medium comprises a fiber-optic link.

7. The antenna system of claim 6, wherein the fiber-optic link comprises:
a first converter operable to receive the radio frequency signal or the intermediate frequency signal, convert the radio frequency signal or the intermediate frequency signal to a light signal and to output the light signal;
a fiber-optic cable operable to transmit the light signal between the beamformer and the antenna; and
a second converter operable to receive the light signal, convert the light signal to recover the radio frequency signal or the intermediate frequency signal, and to output the radio frequency signal or the intermediate frequency signal.

8. The antenna system of claim 1, wherein the deployed antenna is transmitting a radio frequency signal and the beamformer is a radio frequency beamformer and wherein:
the transmission medium comprises a fiber-optic link comprising:
a first converter coupled to the beamformer and operable to convert an input radio frequency signal to a light signal and to output the light signal,
a fiber-optic cable operable to transmit the light signal, and
a second converter coupled to the antenna operable to receive the light signal and to convert the light signal to an output radio frequency signal; and
the antenna further comprises:
a power amplifier operable to receive the radio frequency signal from the second converter and to amplify the radio frequency signal,
a filter operable to filter the amplified radio frequency signal and output the filtered radio frequency signal, and
an antenna element operable to receive the filtered radio frequency signal and to radiate the filtered radio frequency signal.

9. The antenna system of claim 8, wherein the beamformer comprises:
a plurality of power dividers, each power divider having a plurality of outputs, each power divider operable to receive a radio frequency signal, divide the received signal into a plurality of signals and output the plurality of divided signals;
a plurality of phase and amplitude control circuits, each circuit operable to receive a radio frequency signal from a power divider, set the phase and amplitude of the signal to a desired value and output the phase shifted and attenuated signal;
a plurality of power combiner circuits, each power combiner circuit having a plurality of inputs and an output, each output connected to a fiber optic link, each power combiner circuit operable to receive radio frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

10. The antenna system of claim 9, wherein the deployed antenna comprises at least one antenna tile.

11. The antenna system of claim 1, wherein the deployed antenna is transmitting a radio frequency signal and the beamformer is an intermediate frequency beamformer and wherein:
the transmission medium comprises a fiber-optic link comprising:
a first converter coupled to the beamformer and operable to convert an input intermediate frequency signal to a light signal and to output the light signal,
a fiber-optic cable operable to transmit the light signal, and
a second converter coupled to the antenna operable to receive the light signal and to convert the light signal to an output intermediate frequency signal; and
the antenna further comprises:
an up-converter operable to receive the intermediate frequency signal from the second converter, convert the intermediate frequency signal to a radio frequency signal, and output the radio frequency signal to the power amplifier,
a power amplifier operable to amplify the radio frequency signal,
a filter operable to filter the amplified radio frequency signal and output the filtered radio frequency signal, and
an antenna element operable to receive the filtered radio frequency signal and to radiate the filtered radio frequency signal.

12. The antenna system of claim 11, wherein the beamformer comprises:
a plurality of power dividers, each power divider having a plurality of outputs, each power divider operable to receive an intermediate frequency signal, divide the received signal into a plurality of signals and output the plurality of divided signals;
a plurality of phase and amplitude control circuits, each circuit operable to receive an intermediate frequency signal from a power divider, set the phase and amplitude of the signal to a desired value and output the phase shifted and attenuated signal;
a plurality of power combiner circuits, each power combiner circuit having a plurality of inputs and an output, each output connected to a fiber optic link, each power combiner circuit operable to receive intermediate frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

13. The antenna system of claim 12, wherein the deployed antenna comprises at least one antenna tile.

14. The antenna system of claim 1, wherein the deployed antenna is receiving a radio frequency signal and the beamformer is a radio frequency beamformer and wherein:
the antenna further comprises:
an antenna element operable to receive the radio frequency signal and output the radio frequency signal,
a filter operable to receive the radio frequency signal from the antenna element, filter the radio frequency signal, and output the filtered radio frequency signal, and
an amplifier operable to receive the radio frequency signal from the filter, amplify the radio frequency signal, and output an amplified radio frequency signal; and
the transmission medium comprises a fiber-optic link comprising:
a first converter coupled to the amplifier and operable to convert an input radio frequency signal to a light signal and to output the light signal,
a fiber-optic cable operable to transmit the light signal, and
a second converter coupled to the beamformer operable to receive the light signal and to convert the light signal to an output radio frequency signal.

15. The antenna system of claim 14, wherein the beamformer comprises:
a plurality of power dividers, each power divider having a plurality of outputs, each power divider operable to receive a radio frequency signal from a fiber optic link, divide the received signal into a plurality of signals and output the plurality of divided signals;
a plurality of phase and amplitude control circuits, each circuit operable to receive a radio frequency signal from a power divider, set the phase and amplitude of the signal to a desired value and output the phase shifted and attenuated signal;
a plurality of power combiner circuits, each power combiner circuit having a plurality of inputs, each power combiner circuit operable to receive radio frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

16. The antenna system of claim 15, wherein the deployed antenna comprises at least one antenna tile.

17. The antenna system of claim 1, wherein the deployed antenna is receiving a radio frequency signal and the beamformer is an intermediate frequency beamformer and wherein:
the antenna further comprises:
an antenna element operable to receive the radio frequency signal and output the radio frequency signal,
a filter operable to receive the radio frequency signal from the antenna element, filter the radio frequency signal, and output the filtered radio frequency signal,
an amplifier operable to receive the radio frequency signal from the filter, amplify the radio frequency signal, and output an amplified radio frequency signal,
a down-converter operable to receive the amplified radio frequency signal from the amplifier, convert the radio frequency signal to an intermediate frequency signal, and output the intermediate frequency signal; and
the transmission medium comprises a fiber-optic link comprising:
a first converter coupled to the down-converter and operable to convert an input intermediate frequency signal to a light signal and to output the light signal,
a fiber-optic cable operable to transmit the light signal, and
a second converter coupled to the beamformer operable to receive the light signal and to convert the light signal to an output intermediate frequency signal.

18. The antenna system of claim 17, wherein the beamformer comprises:
a plurality of power dividers, each power divider having a plurality of outputs, each power divider operable to receive an intermediate frequency signal from a fiber optic link, divide the received signal into a plurality of signals and output the plurality of divided signals;
a plurality of phase and amplitude control circuits, each circuit operable to receive an intermediate frequency signal from a power divider, set the phase and amplitude of the signal to a desired value and output the phase shifted and attenuated signal;
a plurality of power combiner circuits, each power combiner circuit having a plurality of inputs, each power combiner circuit operable to receive intermediate frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

19. The antenna system of claim 18, wherein the deployed antenna comprises at least one antenna tile.

20. The antenna system of claim 1, wherein the transmission medium comprises a coaxial cable.

21. An antenna array system comprising:
a deployed antenna array comprising a plurality of antennas operable to transmit or receive a radio frequency signal;
a beamformer mounted in a body of the spacecraft operable to process a radio frequency signal or an intermediate frequency signal; and
a transmission medium operable to communicate the radio frequency signal or the intermediate frequency signal between the beamformer and the deployed antenna.

22. The antenna array system of claim 21, wherein the transmission medium comprises a plurality of fiber-optic links.

23. The antenna array system of claim 22, wherein each fiber-optic link comprises:
a first converter operable to receive the radio frequency signal or the intermediate frequency signal, convert the radio frequency signal or the intermediate frequency signal to a light signal and to output the light signal;
a fiber-optic cable operable to transmit the light signal between the beamformer and the antenna; and
a second converter operable to receive the light signal, convert the light signal to recover the radio frequency signal or the intermediate frequency signal, and to output the radio frequency signal or the intermediate frequency signal.

24. The antenna array system of claim 23, wherein each antenna comprises at least one antenna tile.

25. The antenna array system of claim 21, wherein each antenna comprises at least one antenna tile.

26. The antenna array system of claim 25, wherein the transmission medium comprises a plurality of fiber-optic links.

27. The antenna array system of claim 26, wherein each fiber-optic link comprises:
a first converter operable to receive the radio frequency signal or the intermediate frequency signal, convert the radio frequency signal or the intermediate frequency signal to a light signal and to output the light signal;
a fiber-optic cable operable to transmit the light signal between the beamformer and the antenna; and
a second converter operable to receive the light signal, convert the light signal to recover the radio frequency signal or the intermediate frequency signal, and to output the radio frequency signal or the intermediate frequency signal.

28. The antenna array system of claim 21, wherein the deployed antenna is transmitting radio frequency signals and the beamformer is a radio frequency beamformer and wherein:
the transmission medium comprises a plurality of fiber-optic links, each fiber optic link comprising:
a first converter coupled to the beamformer and operable to convert an input radio frequency signal to a light signal and to output the light signal,
a fiber-optic cable operable to transmit the light signal, and
a second converter coupled to an antenna and operable to receive the light signal and to convert the light signal to an output radio frequency signal; and
each antenna comprises:
a plurality of power amplifiers, each power amplifier operable to receive a radio frequency signal from a second converter and to amplify the radio frequency signal,
a plurality of filters, each filter operable to filter an amplified radio frequency signal from a power amplifier, and
a plurality of antenna elements, each antenna element operable to radiate the filtered radio frequency signal.

29. The antenna array system of claim 28, wherein the beamformer comprises:
a plurality of power dividers, each power divider having a plurality of outputs, each power divider operable to receive a radio frequency signal, divide the received signal into a plurality of signals and output the plurality of divided signals;
a plurality of phase and amplitude control circuits, each circuit operable to receive a radio frequency signal from a power divider, set the phase and amplitude of the signal to a desired value and output the phase shifted and attenuated signal;
a plurality of power combiner circuits, each power combiner circuit having a plurality of inputs and an output, each output connected to a fiber optic link, each power combiner circuit operable to receive radio frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

30. The antenna array system of claim 29, wherein each antenna comprises at least one antenna tile.

31. The antenna array system of claim 21, wherein the deployed antenna is transmitting a radio frequency signal and the beamformer is an intermediate frequency beamformer and wherein:
the transmission link comprises a plurality of fiber-optic links, each fiber optic link comprising:
a first converter coupled to the beamformer and operable to convert an input intermediate frequency signal to a light signal and to output the light signal,
a fiber-optic cable operable to transmit the light signal, and
a second converter coupled to an antenna and operable to receive the light signal and to convert the light signal to an output intermediate frequency signal; and
each antenna comprises:
a plurality of up-converters, each up-converter operable to receive an intermediate frequency signal from a second converter and convert the intermediate frequency signal to a radio frequency signal,
a plurality of power amplifiers, each power amplifier operable to amplify a radio frequency signal,
a plurality of filters, each filter operable to filter an amplified radio frequency signal, and
a plurality of antenna elements, each antenna element operable to transmit a filtered radio frequency signal.

32. The antenna array system of claim 31, wherein the beamformer comprises:
a plurality of power dividers, each power divider having a plurality of outputs, each power divider operable to receive an intermediate frequency signal, divide the received signal into a plurality of signals and output the plurality of divided signals;
a plurality of phase and amplitude control circuits, each circuit operable to receive an intermediate frequency signal from a power divider, set the phase and amplitude of the signal to a desired value and output the phase shifted and attenuated signal;
a plurality of power combiner circuits, each power combiner circuit having a plurality of inputs and an output, each output connected to a fiber optic link, each power combiner circuit operable to receive intermediate frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

33. The antenna array system of claim 32, wherein each antenna comprises at least one antenna tile.

34. The antenna array system of claim 21, wherein the deployed antenna is receiving radio frequency signals and the beamformer is a radio frequency beamformer and wherein:
each antenna comprises:
a plurality of antenna elements, each antenna element operable to receive a radio frequency signal,
a plurality of filters, each filter operable to receive a radio frequency signal from an antenna element, filter the amplified radio frequency signal, and output the filtered radio frequency signal, and
a plurality of amplifiers, each amplifier operable to receive a radio frequency signal from a filter, amplify the radio frequency signal, and output an amplified radio frequency signal; and
the transmission link comprises a plurality of fiber-optic links, each fiber optic link comprising:
a first converter coupled to the amplifier and operable to convert an input radio frequency signal to a light signal and to output the light signal,
a fiber-optic cable operable to transmit the light signal, and
a second converter coupled to the beamformer operable to receive the light signal and to convert the light signal to an output radio frequency signal.

35. The antenna array system of claim 34, wherein the beamformer comprises:
a plurality of power dividers, each power divider having a plurality of outputs, each power divider operable to receive a radio frequency signal from a fiber optic link, divide the received signal into a plurality of signals and output the plurality of divided signals;
a plurality of phase and amplitude control circuits, each circuit operable to receive a radio frequency signal from a power divider, set the phase and amplitude of the signal to a desired value and output the phase shifted and attenuated signal;
a plurality of power combiner circuits, each power combiner circuit having a plurality of inputs, each power combiner circuit operable to receive radio frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

36. The antenna array system of claim 35, wherein each antenna comprises at least one antenna tile.

37. The antenna array system of claim 21, wherein the deployed antenna is receiving radio frequency signals and the beamformer is an intermediate frequency beamformer and wherein:
each antenna comprises:
a plurality of antenna elements, each antenna element operable to receive a radio frequency signal,
a plurality of filters, each filter operable to receive a radio frequency signal from an antenna element, filter the amplified radio frequency signal, and output the filtered radio frequency signal,
a plurality of amplifiers, each amplifier operable to receive a radio frequency signal from a filter, amplify the radio frequency signal, and output an amplified radio frequency signal, and
a plurality of down-converters operable to receive an amplified radio frequency signal from an amplifier, convert the radio frequency signal to an intermediate frequency signal, and output the intermediate frequency signal; and
the transmission link comprises a plurality of fiber-optic links, each fiber optic link comprising:
a first converter coupled to the down-converter and operable to convert an input intermediate frequency signal to a light signal and to output the light signal,
a fiber-optic cable operable to transmit the light signal, and
a second converter coupled to the beamformer operable to receive the light signal and to convert the light signal to an output intermediate frequency signal.

38. The antenna array system of claim 37, wherein the beamformer comprises:
a plurality of power dividers, each power divider having a plurality of outputs, each power divider operable to receive an intermediate frequency signal from a fiber optic link, divide the received signal into a plurality of signals and output the plurality of divided signals;
a plurality of phase and amplitude control circuits, each circuit operable to receive an intermediate frequency signal from a power divider, set the phase and amplitude of the signal to a desired value and output the phase shifted and attenuated signal;
a plurality of power combiner circuits, each power combiner circuit having a plurality of inputs, each power combiner circuit operable to receive intermediate frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

39. The antenna array system of claim 38, wherein each antenna comprises at least one antenna tile.

40. The antenna array system of claim 21, wherein the transmission medium comprises a coaxial cable.

41. A spacecraft comprising:
a deployed antenna array comprising a plurality of antennas operable to transmit or receive a radio frequency signal;
a beamformer mounted in a body of the spacecraft operable to process a radio frequency signal or an intermediate frequency signal; and
a transmission medium operable to communicate the radio frequency signal or the intermediate frequency signal between the beamformer and the deployed antenna.

42. The spacecraft of claim 41, wherein the transmission medium comprises a plurality of fiber-optic links.

43. The spacecraft of claim 42, wherein each fiber-optic link comprises:
a first converter operable to receive the radio frequency signal or the intermediate frequency signal, convert the radio frequency signal or the intermediate frequency signal to a light signal and to output the light signal;
a fiber-optic cable operable to transmit the light signal between the beamformer and the antenna; and
a second converter operable to receive the light signal, convert the light signal to recover the radio frequency signal or the intermediate frequency signal, and to output the radio frequency signal or the intermediate frequency signal.

44. The spacecraft of claim 43, wherein each antenna comprises at least one antenna tile.

45. The spacecraft of claim 41, wherein each antenna comprises at least one antenna tile.

46. The spacecraft of claim 45, wherein the transmission medium comprises a plurality of fiber-optic links.

47. The spacecraft of claim 46, wherein each fiber-optic link comprises:
a first converter operable to receive the radio frequency signal or the intermediate frequency signal, convert the radio frequency signal or the intermediate frequency signal to a light signal and to output the light signal;
a fiber-optic cable operable to transmit the light signal between the beamformer and the antenna; and
a second converter operable to receive the light signal, convert the light signal to recover the radio frequency signal or the intermediate frequency signal, and to output the radio frequency signal or the intermediate frequency signal.

48. The spacecraft of claim 41, wherein the deployed antenna is transmitting radio frequency signals and the beamformer is a radio frequency beamformer and wherein:
the transmission link comprises a plurality of fiber-optic links, each fiber optic link comprising:
a first converter coupled to the beamformer and operable to convert an input radio frequency signal to a light signal and to output the light signal,
a fiber-optic cable operable to transmit the light signal, and
a second converter coupled to an antenna and operable to receive the light signal and to convert the light signal to an output radio frequency signal; and
each antenna comprises:
a plurality of power amplifiers, each power amplifier operable to receive a radio frequency signal from a second converter and to amplify the radio frequency signal,
a plurality of filters, each filter operable to filter an amplified radio frequency signal from a power amplifier, and
a plurality of antenna elements, each antenna element operable to transmit the a filtered radio frequency signal.

49. The spacecraft of claim 48, wherein the beamformer comprises:
a plurality of power dividers, each power divider having a plurality of outputs, each power divider operable to receive a radio frequency signal, divide the received signal into a plurality of signals and output the plurality of divided signals;
a plurality of phase and amplitude control circuits, each circuit operable to receive a radio frequency signal from a power divider, set the phase and amplitude of the signal to a desired value and output the phase shifted and attenuated signal;
a plurality of power combiner circuits, each power combiner circuit having a plurality of inputs and an output, each output connected to a fiber optic link, each power combiner circuit operable to receive radio frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

50. The spacecraft of claim 49, wherein each antenna comprises at least one antenna tile.

51. The spacecraft of claim 41, wherein the deployed antenna is transmitting a radio frequency signal and the beamformer is an intermediate frequency beamformer and wherein:
the transmission link comprises a plurality of fiber-optic links, each fiber optic link comprising:
a first converter coupled to the beamformer and operable to convert an input intermediate frequency signal to a light signal and to output the light signal,
a fiber-optic cable operable to transmit the light signal, and
a second converter coupled to an antenna and operable to receive the light signal and to convert the light signal to an output intermediate frequency signal; and
each antenna comprises:
a plurality of up-converters, each up-converter operable to receive an intermediate frequency signal from a second converter and convert the intermediate frequency signal to a radio frequency signal,
a plurality of power amplifiers, each power amplifier operable to amplify a radio frequency signal,
a plurality of filters, each filter operable to filter an amplified radio frequency signal, and
a plurality of antenna elements, each antenna element operable to transmit a filtered radio frequency signal.

52. The spacecraft of claim 5 1, wherein the beamformer comprises:
a plurality of power dividers, each power divider having a plurality of outputs, each power divider operable to receive an intermediate frequency signal, divide the received signal into a plurality of signals and output the plurality of divided signals;
a plurality of phase and amplitude control circuits, each circuit operable to receive an intermediate frequency signal from a power divider, set the phase and amplitude of the signal to a desired value and output the phase shifted and attenuated signal;
a plurality of power combiner circuits, each power combiner circuit having a plurality of inputs and an output, each output connected to a fiber optic link, each power combiner circuit operable to receive intermediate frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

53. The spacecraft of claim 52, wherein each antenna comprises at least one antenna tile.

54. The spacecraft of claim 41, wherein the deployed antenna is receiving radio frequency signals and the beamformer is a radio frequency beamformer and wherein:
each antenna comprises:
a plurality of antenna elements, each antenna element operable to receive a radio frequency signal,
a plurality of filters, each filter operable to receive a radio frequency signal from an antenna element, filter the amplified radio frequency signal, and output the filtered radio frequency signal, and
a plurality of amplifiers, each amplifier operable to receive a radio frequency signal from a filter, amplify the radio frequency signal, and output an amplified radio frequency signal; and
the transmission link comprises a plurality of fiber-optic links, each fiber optic link comprising:
a first converter coupled to the amplifier and operable to convert an input radio frequency signal to a light signal and to output the light signal,
a fiber-optic cable operable to transmit the light signal, and
a second converter coupled to the beamformer operable to receive the light signal and to convert the light signal to an output radio frequency signal.

55. The spacecraft of claim 54, wherein the beamformer comprises:
a plurality of power dividers, each power divider having a plurality of outputs, each power divider operable to receive a radio frequency signal from a fiber optic link, divide the received signal into a plurality of signals and output the plurality of divided signals;
a plurality of phase and amplitude control circuits, each circuit operable to receive a radio frequency signal from a power divider, set the phase and amplitude of the signal to a desired value and output the phase shifted and attenuated signal;
a plurality of power combiner circuits, each power combiner circuit having a plurality of inputs, each power combiner circuit operable to receive radio frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

56. The spacecraft of claim 55, wherein each antenna comprises at least one antenna tile.

57. The spacecraft of claim 41, wherein the deployed antenna is receiving radio frequency signals and the beamformer is an intermediate frequency beamformer and wherein:
each antenna comprises:
a plurality of antenna elements, each antenna element operable to receive a radio frequency signal,
a plurality of filters, each filter operable to receive a radio frequency signal from an antenna element, filter the amplified radio frequency signal, and output the filtered radio frequency signal,
a plurality of amplifiers, each amplifier operable to receive a radio frequency signal from a filter, amplify the radio frequency signal, and output an amplified radio frequency signal
a plurality of down-converters operable to receive an amplified radio frequency signal from an amplifier, convert the radio frequency signal to an intermediate frequency signal, and output the intermediate frequency signal; and the transmission link comprises a plurality of fiber-optic links, each fiber optic link comprising:
a first converter coupled to the down-converter and operable to convert an input intermediate frequency signal to a light signal and to output the light signal,
a fiber-optic cable operable to transmit the light signal, and
a second converter coupled to the beamformer operable to receive the light signal and to convert the light signal to an output intermediate frequency signal.

58. The spacecraft of claim 57, wherein the beamformer comprises:
a plurality of power dividers, each power divider having a plurality of outputs, each power divider operable to receive an intermediate frequency signal from a fiber optic link, divide the received signal into a plurality of signals and output the plurality of divided signals;
a plurality of phase and amplitude control circuits, each circuit operable to receive an intermediate frequency signal from a power divider, set the phase and amplitude of the signal to a desired value and output the phase shifted and attenuated signal;
a plurality of power combiner circuits, each power combiner circuit having a plurality of inputs, each power combiner circuit operable to receive intermediate frequency signals from a plurality of phase and amplitude control circuits, combine these signals into a composite signal, and output the composite signal;
wherein the plurality of power dividers, phase and amplitude control circuits and power combiners are arranged so that one of the plurality of outputs from each power divider is connected through a phase and amplitude control circuit to one of the plurality of inputs of each of the plurality of power combiners; and
wherein one of the plurality of inputs to each power combiner is connected through a phase and amplitude control circuit to one of the plurality of outputs of each of the plurality power dividers.

59. The spacecraft of claim 58, wherein each antenna comprises at least one antenna tile.

60. The spacecraft of claim 41, wherein the transmission medium comprises a coaxial cable.
